(19) United States
(12) Patent Application Publication
(10) Pub. No.: US 2024/0330278 A1
(43) Pub. Date: Oct. 3, 2024

(54) PROVIDING QUERY RESULTS AND RELEVANCE DESCRIPTORS BY PREDICATE BASED ENTITY EXPANSION

(71) Applicant: Google LLC, Mountain View, CA (US)

(72) Inventors: Miquel Angel Farré Guiu, Bern (CH); Koen Alexander Vernooij, Zürich (CH); Florian Robert Felix Rock, Zürich (CH); Johannes Wilhelm Heribert Klumpe, Zürich (CH)

(21) Appl. No.: 18/130,390

(22) Filed: Apr. 3, 2023

(51) Int. Cl. G06F 16/242; G06F 9/451; G06F 16/248

(52) U.S. Cl. CPC G06F 16/2428; G06F 9/451; G06F 16/248

(57) ABSTRACT

A method includes receiving, by a processor of a first user device, a user query. The method further includes providing the user query to a server. The method further includes receiving from the server a matching result associated with the user query. The method further includes providing, in a user interface (UI) on the first user device, a plurality of UI elements. The UI elements include a first UI element presenting the matching result associated with the query. The UI elements include a second UI element presenting a relevance descriptor associated with a relationship between the user query and the matching result associated with the user query.

### TECHNICAL FIELD

Aspects and implementations of the present disclosure relate to methods and systems for providing query results, specifically providing query results by predicate-based expansion of query and query result entities.

### BACKGROUND

A platform (e.g., a content sharing platform) can transmit (e.g., stream) media items to client devices connected to the platform via a network. A user may submit, via a client device, a query. The content sharing platform may provide one or more potential matches associated with the user query.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

A system and method are disclosed for receiving, by a processor of a first user device, a user query. The method further includes providing the user query to a server. The method further includes receiving from the server a matching result associated with the user query. The method further includes providing, in a user interface (UI) on the first user device, a plurality of UI elements. The UI elements include a first UI element presenting the matching result associated with the query. The UI elements include a second UI element presenting a relevance descriptor associated with a relationship between the user query and the matching result associated with the user query. The relevance descriptor may be or include a substring of the user query.

Matching results associated with the user query may be determined using a knowledge graph. The knowledge graph may include nodes representing entities and edges representing predicate relationships between entities. The relevance descriptor may be determined based on an overlap between one or more entities associated with the user query and one or more entities associated with the matching result associated with the user query.

A method and system for performing the method are disclosed. The method includes receiving, by a server device from a first user device, a user query. The method further includes determining that a first plurality of entities is associated with the user query. The method further includes determining that a first entity of the first plurality of entities overlaps with a second entity of a first query result. The method further includes providing the first query result for display by the first user device. The method further includes providing a relevance descriptor associated with a relationship between the use query and the first query result for display by the first user device.

In some embodiments, the relevance descriptor may be based on the first entity. The relevance descriptor may be based on a predicate relationship of the first entity.

In some embodiments, determining that the first plurality of entities is associated with the user query may include determining a third entity is directly related to the user query. Determining that the first plurality of entities is associated with the user query may further include determining that the first entity has a relationship with the third entity defined by a first predicate. The first plurality of entities includes the first entity and the third entity in some embodiments. The relevance descriptor may be based on the first predicate.

In some embodiments, determining that the second entity is associated with the first query result may include determining a fourth entity is directly related to the first query result. Determining that the second entity is associated with the first query result may further include determining that the fourth entity has a relationship with the second entity defined by a second predicate. The relevance descriptor may be based on the second predicate. Providing the relevance descriptor may include determining that the first predicate belongs to a first plurality of predicates associated with relevance descriptors. The first plurality of predicates is a subset of a second plurality of predicates. The second plurality of predicates may be used to determine a set of entities associated with the query result.

In some embodiments, determining that the first plurality of entities is associated with the user query may include determining that a second plurality of entities is directly associated with the user query. The second plurality of entities is a subset of the first plurality of entities. A third plurality of entities exists, that includes entities that are of the first plurality of entities but not the second plurality of entities. Determining that the first plurality of entities is associated with the user query further may include determining that each of the third plurality of entities is related to one or more of the second plurality of entities by a predicate relationship belonging to a set of predicate relationships. The set of predicate relationships may be a curated set of predicates based on a likelihood that the predicates generate matches having relevance to each other as perceived by a user.

A further method and system for performing the method are disclosed. The method includes determining, by a processing device, a first plurality of entities associated with a user query. The method further includes determining, by the processing device, a second plurality of entities associated with a query result. The method further includes expanding at least one of the first plurality of entities or the second plurality of entities based on a predicate relationship of the respective plurality of entities. Expanding the plurality of entities may be to generate at least one of an expanded first plurality of entities or an expanded second plurality of entities. The predicate relationship belongs to a first plurality of predicate relationships. The method further includes determining that a first entity belongs to either the first plurality of entities and the expanded second plurality of entities or the second plurality of entities and the expanded first plurality of entities. The method further includes providing the query result as a match to the user query.

In some embodiments, the method further includes providing a relevance descriptor for display by a user device. The relevance descriptor may be based on the query result, the user query, and the first entity. The relevance descriptor may be based on the predicate relationship.

In some embodiments, generating the first plurality of predicate relationships may include receiving a test query. Generating the first plurality of predicate relationships may further include determining a third plurality of entities directly associated with the test query. Generating the first plurality of predicate relationships may further include expanding the third plurality of entities based on a test predicate relationship to generate an expanded third plurality of entities. The expanded third plurality of entities may include a second entity. Generating the first plurality of predicate relationships may further include determining that a test query result is associated with the second entity. Generating the first plurality of predicate relationships may further include providing the test query and the test query result to an evaluation module. The evaluation module may provide human evaluation of the test query and the test query result. Generating the first plurality of predicate relationships may further include receiving output of the evaluation module associated with the test query and the test query result. Generating the first plurality of predicate relationships may further include determining whether to include the test predicate relationships in the first plurality of predicate relationships based on the output of the evaluation module.

In some embodiments, the processing device may further cause a UI element to be provided to a user. The UI element may include an indication of the query result. The processing device may further update the first plurality of predicate relationships based on user interaction with the UI element.

In some embodiments, the method further includes providing the user query and the query result to a relevance model. The method may further include receiving a relevance score from the relevance model. The method may further include updating the first plurality of predicate relationships based on the relevance score.

In some embodiments, the method further includes determining whether to provide a relevance descriptor for display by a user device. The determination is based on whether the predicate relationship belongs to a second plurality of predicate relationships. The second plurality of predicate relationships may be a subset of the first plurality of predicate relationships.

In some embodiments, the method further includes obtaining a first confidence score. The first confidence score is indicative of a certainty that the first entity is related to the user query. The method may further include obtaining a second confidence score. The second confidence score indicates a certainty that the first entity is related to the query result. Determining whether to provide the query result as a match to the user query may be based on the first confidence score and the second confidence score. The first confidence score may be associated with a first probability. The second confidence score may be associated with a second probability. Determining to provide the query result as a match to the user query may be based on a multiplicative probability.

Optional features of one aspect may be combined with other aspects where appropriate.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for receiving queries and providing related query results, according to some embodiments.

FIG. 2 is an example graphical user interface (GUI) of a communication application of a client device, including an explainability UI element, according to some embodiments

FIG. 3A is a block diagram of a flow of operations for query/result matching using expanded sets of entities, according to some embodiments.

FIG. 3B is an example knowledge graph including entities and predicates, according to some embodiments.

FIG. 4A is a flow diagram of a method for providing a relevance descriptor associated with a query result to a user, according to some embodiments.

FIG. 4B is a flow diagram of a method for utilizing entity overlap to provide a relevance descriptor for a query result, according to some embodiments.

FIG. 4C is a flow diagram of a method for providing a query result as a match to a query using predicate expansion of entities, according to some embodiments.

FIG. 5 is a block diagram illustrating an exemplary computer system, in accordance with implementations of the present disclosure.

### DETAILED DESCRIPTION

Aspects of the present disclosure relate to methods and systems for improving relevance of results returned in response to a user request. A platform (e.g., a content sharing platform, etc.) can enable a user to provide a query, e.g., via a network. Results of the query may enable a user to access a media item (e.g., a video item, an audio item, etc.) hosted by the platform (e.g., via a client device connected to the platform). Results of the query may also provide an advertisement to the user. The platform can provide a client device of the user with access to one or more matches to the query (e.g., by transmitting a list including query matches to the client device of the user, etc.) via the network. Matches between queries and results may be accomplished following entity and predicate logic, e.g., of a knowledge graph.

In some systems, query matches may be found based on exact matching operations. Exact matching may include searching for exact matches between a query and a query result. Exact matching may include searching for exact matches between a query and a set of annotations associated with a query result. Exact matching may include searching for exact matches between subdivisions (e.g., substrings) of a query and a set of annotations associated with a query result.

Exact matching operations typically have limitations. Exact matching operations may depend upon annotations of query matches. Annotations of query matches may not be comprehensive, may be cumbersome to implement, may not enable related query match items to be connected, etc. Annotations may depend on human labeling, which may be expensive and/or error prone. Annotations may depend upon machine learning-based labeling, which may not accurately represent human-perceived relevance. Exact matching may depend upon exact phrases used in a query, which may limit available exact query results. Exact matching results may depend upon substring parsing. Exact matching results may be input language dependent.

In some systems, query matches may be found based on embedding operations. Embedding may include providing a query and potential query result match to a machine learning embedding model. The model may determine a relevance between a query and a potential query result. For example, the embedding model may represent the query and field of potential query results in a N-dimensional vector space. A vector distance (e.g., cosine distance) may be indicative of a similarity or relevance between objects represented in the vector space.

Embedding based query matching may have several shortcomings. Threshold distance matching techniques may not translate perfectly to human-recognized relevance. Different regions of the embedding space may be more sparsely or densely populated, e.g., in training data. Different regions of the embedding space may have different threshold distances that translate to human-recognized relevance. Different regions of the embedding space may act differently (e.g., unpredictably) under transformation. Relevant distance thresholds may be difficult to establish for the vector space. Generation of the embedding space may require a large volume of human-labeled data. Generation of training data may be expensive and/or time consuming. Generation of the embedding model may be computationally expensive. The embedding model may need to be frequently updated, to keep up with new query results, new trends in queries, etc.

In some systems, entity based query matching may be utilized. Entity based query matching may assign entities associated with both queries and potential query results. Entities may include objects, concepts, ideas, topics, products, events, etc. Entities may be assigned that are relevant to a particular query or potential query result. Entities may be assigned manually, based on machine learning, etc. Query matching may include searching for overlapping entities between a query and potential query results. Entity matching may have several shortcomings. Entity matches are typically sparse. Entity matching may miss obviously related objects if they are not annotated with the appropriate entities.

Methods and systems of the present disclosure may address one or more of the shortcomings of conventional methods. In some embodiments, a knowledge graph is generated and utilized for query/result matching. A knowledge graph may include entities (e.g., nodes of the graph) connected by predicates (e.g., edges of the graph). Generating a match between a query and a query result may include determining whether an entity associated with the query and an entity associated with a potential query result overlap.

Determining a set of entities that are associated with a query or a query result may include referencing the knowledge graph of entities and predicates. A set of predicates may be specified as appropriate for query/result matching. The set of predicates may be curated by testing for human-recognized relevance. The set of predicates may be curated by determining relevance via a model, such as a machine learning model.

Responsive to receiving a query, a processing device may assign one or more entities to the query. Initial entity assignment may be based, for example, on query text, a query string, one or more query substrings, computer parsing of query text, machine learning output based on the query, user history, etc. A set of entities associated with the query may be expanded utilizing the knowledge graph and the curated set of predicates. Any entity that is connected via one of the curated set of predicates to an entity initially associated with the query may be included in an expanded set of entities. Further expansions may be performed via predicates to further entities. An entity match may be found between the expanded set of entities of the query and a set of entities associated with a potential query result.

An expanded set of entities may further be associated with a potential query result. The query result may be assigned an initial set of entities. The initial set of entities associated with a potential query result may be expanded utilizing the knowledge graph. A set of curated predicates may be used to expand the initial set of entities to an expanded set of entities. The expanded set of entities may be used to match a potential query result to a query. An expanded set of entities may be utilized for the query, potential query results, or both.

In some embodiments, expanded entity matching may be utilized in providing a description of the relevance of a query result to a query. A query result may be displayed to a user with an explanation of a relationship between the query and the query result. The explanation may be provided based on an overlapping entity between the query and query result. The explanation provided may be based on a predicate connecting an initial set of entities to an expanded set of entities. Providing the explanation may be performed responsive to a predicate belonging to a second curated set of predicates, e.g., a subset of the curated set of predicates utilized in entity expansion.

Systems and methods of the present disclosure provide technical advantages over conventional methods. Exact matching methods provide sparse matching results. Sparse results may negatively impact a user experience. Sparse results may necessitate further queries for a user to find a relevant result, which may include an expenditure of additional time, computing resources, etc., for the additional searches. Exact matching methods may provide results that are language dependent, term dependent, etc. Shortcomings related to sparsity of results may be compounded by use of multiple languages on a platform, multiple synonymous or related terms for a query subject, etc. Expansion of entities via predicate connections in a knowledge graph may increase relevant query results matched to a query. Expansion of match results may improve a user experience. Expansions of match results may improve chances of a first query including a relevant result, reducing computing load from multiple consecutive searches for sparse results.

Embedding methods for determining query results may include a large expenditure of resources in generating and maintaining the embedding space. The embedding space may be generated by a machine learning model. Generating the embedding space may include providing a large amount of training data to the machine learning model. Training, testing, and validating the machine learning model may involve a considerable expenditure of time, computing resources, etc. Maintaining the embedding space (e.g., by retraining, updating the models, etc.) may necessitate continuing expenditure of computing resources. Embedding methods may further provide unreliable or inconsistent matching relevance. Relevance matching via embedding methods may be an abstract process, without clear indications of logic for matching. Query result matching based on knowledge graph-extended entity sets may not require generation of an embedding space. Computational resources associated with generating and maintaining the embedding space may be conserved by utilizing expanded entity matching. Matches between queries and query results generated by expanded entity matching may be easily explained, e.g., via entity matching, knowledge graph predicate logic, etc. Relevance may be tuned by tuning the curated set of predicates.

Entity based matching methods suffer from many of the computational limitations of exact matching methods. Entity based matching methods may provide sparse results. Sparse return results may result in additional expenditure of computing resources for performing additional sources, a sub-optimal user experience, etc.

Providing an explanation of relevance of a query result to a query may further improve matching operations. Providing explanation of relevance may improve a user experience. Providing an explanation of relevance may enable a user to more quickly refine query terms to find a relevant result. Enabling refining of query terms may reduce a number of queries to achieve a target result, which may reduce computational resources devoted to multiple searching/matching operations.

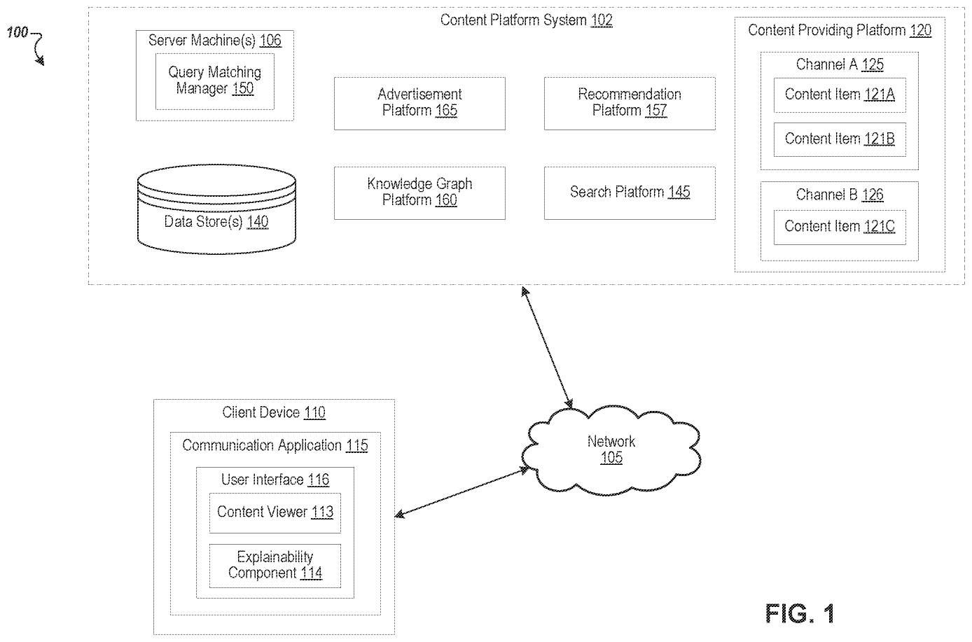

FIG. 1 illustrates an example system architecture 100 for receiving queries and providing related query results, according to some embodiments. System architecture 100 includes client device 110 (in some embodiments, more client devices may be included, e.g., devices 110B, 110C, etc.), one or more networks 105, and content platform system 102. Content platform system 102 includes one or more server machines 106, one or more data stores 140, and may include a variety of platforms targeted at performing tasks (e.g., tasks associated with content delivery). Platforms of content platform system 102 may be hosted by one or more server machines 106. Platforms of content platform system 102 may include and/or be hosted on one or more computing devices (such as a rackmount server, a router computer, a server computer, a personal computer, a mainframe computer, a laptop computer, a tablet computer, a desktop computer, etc.) and one or more data stores (e.g., hard disks, memories, and databases) and may be coupled to the one or more networks 105. In some embodiments, components of content platform system 102 (e.g., server machines 106, data stores 140, hardware associated with one or more platforms, etc.) may be directly connected to one or more networks 105. In some embodiments, one or more components of content platform system 102 may access networks 105 via another device, e.g., a hub, switch, etc. Data stores 140 may be included in one or more server machines 106, include external data storage, etc. Platforms of content platform system 102 may include advertisement platform 165, knowledge graph platform 160, recommendation platform 157, search platform 145, and content providing platform 120.

The one or more networks 105 may include one or more public networks (e.g., the Internet), one or more private networks (e.g., a local area network (LAN), a wide area network (WAN), one or more wired networks (e.g., Ethernet network), one or more wireless networks (e.g., an 802.11 network), one or more cellular networks (e.g., a Long Term Evolution (LTE) network), routers, hubs, switches, server computers, and/or a combination thereof. In some embodiments, some components of architecture 100 are not directly connected to each other. In some embodiments, system architecture 100 includes multiple separate networks 105.

The one or more data stores 140 may reside in memory (e.g., random access memory), cache, drives (e.g., hard drive), flash drives, etc., and may be part of one or more database systems, one or more file systems, or another type of component or device capable of storing data. The one or more data stores 140 may include multiple storage components (e.g., multiple drives or multiple databases) that may also span multiple computing devices (e.g., multiple server computers). The data store may be persistent storage that is capable of storing data. A persistent storage may be a local storage unit or a remote storage unit, electronic storage units (e.g., main memory), or a similar storage unit. Persistent storage may be a monolithic device or a distributed set of devices.

Content items 121A-C (e.g., media content items) may be stored on one or more data stores. The data stores may be part of one or more platforms. Examples of a content item 121 may include, and are not limited to, digital video, digital movies, animated images, digital photos, digital music, digital audio, digital video games, collaborative media content presentations, website content, social media updates, electronic books, electronic journals, digital audio books, web blogs, software applications, etc. Content items 121A-C may also be referred to as media items. Content items 121A-C may be pre-recorded or live-streamed. For brevity and simplicity, a video may be used as an example of a content item 121 throughout this document. Content items 121A-C may be potential query results, may be matched to one or more queries, may be provided to a user in response to a query, etc.

Data store 140 may further store advertisements, e.g., in association with advertisement platform 165. Advertisement storage may include storing advertisement text and images, storing entity association with advertisements, etc. Advertisements may be provided responsive to a user query. One or more advertisements may be provided as query results. One or more advertisements may be provided utilizing expanded entity matching via knowledge graph predicate methods.

Content items 121A-C may be provided by content providers. A content provider may be a user, a company, an organization, etc. A content provider may provide a content item 121 that is a video. A content provider may provide content item 121 that comprises live-streamed content, e.g., content item 121 may include live-streamed video, a live chat associated with the video, etc. Content providers may be provided as query results.

Client devices 110 may include devices, such as televisions, smart phones, personal digital assistants, portable media players, laptop computers, electronic book readers, tablet computers, desktop computers, gaming consoles, set-top boxes, or the like. Client devices 110 may include devices that are used to submit queries, receive query matching results, etc.

A client device 110 (110B, 110C, etc.) may include a communication application 115. A content item 121 may be consumed by a user via the communication application 115. A query may be submitted to content platform system 102 via communication application 115. A query result may be provided to a user via communication application 115. For example, communication application 115 may access one or more networks 105 (e.g., the internet) via hardware of client device 110 to provide content item 121 to the user. As used herein, “media,” “media item,” “online media item,” “digital media,” “digital media item,” “content,” “media content item,” and “content item” may include an electronic file that can be executed or loaded using software, firmware, and/or hardware configured to present a content item. In some embodiments, the communication application 115 may be an application that allow users to compose, send, and receive content items 121 (e.g., videos) over a platform (e.g., content sharing platform 120, recommendation platform 157, advertisement platform 165, knowledge graph platform 160, and/or search platform 145) and/or a combination of platforms and/or networks.

In some embodiments, the communication application 115 may be a social networking application, video sharing application, video streaming application, video game streaming application, photo sharing application, chat application, or an application performing a combination of such functions. The communication application 115 associated with client device 110 may render, display, present and/or play one or more content items 121 to one or more users. For example, communication application 115 may provide user interfaces 116 (e.g., a graphical user interface) to be displayed on client device 110 for receiving, displaying, and/or playing content items.

In some embodiments, communication application 115 may include content viewer 113 and explainability component 114. User interface 116 may display content viewer 113 and explainability component 114. Content viewer 113 may be used to display one or more content items provided via content platform system 102. Content viewer 113 may be used to display one or more results responsive to receiving a user query via user interface 116. In some embodiments, content viewer 113 may display content items as query match results. In some embodiments, content viewer 113 may display one or more advertisements as query match results.

Explainability component 114 may provide a description of relevance of a query result to the associated query. Explainability component 114 may provide information to a user regarding one or more logical connections between the query and the query result. Explainability component 114 may include text, images, video, etc. In some embodiments, explainability component 114 may provide information based on a knowledge graph. In one example, explainability component 114 may provide a relevance description based on entity overlap between the query and the query result. In another example, explainability component 114 may provide a relevance description based on a predicate connection between entities associated with a query. In yet another example, explainability component 114 may provide a relevance description based on a predicate connection between an initial set of entities associated with a query and a knowledge graph-extended set of entities associated with the query. In still another example, explainability component 114 may provide a relevance description based on a predicate connection between entities associated with a query result. In yet another example, explainability component 114 may provide a relevance description based on a predicate connection between an initial set of entities associated with a query result and a knowledge graph-extended set of entities associated with the query result. A explainability component may be based on multiple relevance indications. For example, content of an explainability component may include multiple matched entities, multiple predicate relationships, a combination of entity overlaps and predicate relationships, etc. In some embodiments, explainability component 114 may include information related to a level of relevance of the query and the query result, instead or in addition to displaying entity or predicate information. For example, explainability component 114 may include a plot, icon, description, graphic, or the like communicating a level of relevance. A relevance indicator of explainability component 114 may be related to a number of entity matches between the query and query result, a quality of entity matches (e.g., likelihood of a predicate relationship being evaluated as relevant), one or more confidence levels of matches between query and query results, entities, etc.

In some embodiments, user interface 116 may include a search component, e.g., a field a user may utilize to search for target content item 121, a target content channel (e.g., channel A 125), any content item 121 associated with a target topic, etc. In some embodiments, a search component may provide a user with a virtual keyboard to facilitate user input. In some embodiments, multiple content viewers 113 and/or explainability components 114 may be associated with one user interface, communication application, client device, etc. For example, multiple content items may be displayed for a user at once. Multiple query results may be displayed for a user at once. Multiple relevance descriptions may be displayed for a user at once.

In some implementations, application 115 is a web browser that can access, retrieve, present, and/or navigate content (e.g., web pages such as Hyper Text Markup Language (HTML) pages, digital media items, etc.) and can include explainability component 114 and content viewer 113, which may be an embedded media player that is embedded in user interface 116 (e.g., a web page associated with viewing content) provided by content providing platform 120. Alternatively, application 115 is not a web browser and is a stand-alone application (e.g., mobile application, desktop application, gaming console application, television application, etc.), that is downloaded from a platform (e.g., content providing platform 120) or pre-installed on the client device 110. The stand-alone communication application 115 can provide user interface 116 including content viewer 113 (e.g., embedded media player) and explainability component 114.

In some embodiments, server machine 106 includes query matching manager 150. Query matching manager 150 may perform operations associated with providing query match results based on queries via knowledge graph extension of associated entities. Query matching manager 150 may maintain associations of potential query results (e.g., content items, advertisements, etc.) with entities of a knowledge graph. Query matching manager 150 may monitor performance of entity associations. Query matching manager 150 may monitor performance of entity associations with content items, advertisements, etc. Query matching manager 150 may monitor performance of entity associations by monitoring one or more indications of relevance of associated entities. Indications of relevance may include user selection rate, user view rate, user purchase rate, user dwell rate, or other indications of relevance of query/result matches. Query matching manager 150 may update sets of entities associated with potential query results. Query matching manager 150 may update entities associated with a query result based on results of query matching manager 150 monitoring performance of entity associations.

Query matching manager 150 may maintain one or more sets (e.g., lists) of predicates. A set of predicates may be associated with a target operation. For example, query matching manager 150 may maintain a first list of predicates for expanding entities associated with queries, a second list of predicates for expanding entities associated with query results, a third list of predicates associated with providing relevance descriptors to a user, etc. Query matching manager 150 may monitor performance of sets of predicates. In some embodiments, query matching manager 150 may monitor performance of one or more sets of predicates by monitoring one or more indications of relevance of associated entities, associated query/result pairs, etc. In some embodiments, query matching manager 150 may monitor performance of one or more sets of predicates by monitoring user interaction with provided query matches. In some embodiments, query matching manager 150 may monitor performance of one or more sets of predicates by monitoring user selection rate, user view rate, user purchase rate, user dwell rate, etc. Query matching manager 150 may update one or more sets of predicates. For example, query matching manager 150 may update one or more sets of predicates based on monitoring of predicate performance performed by query matching manager 150.

Query matching manager 150 may facilitate matches between queries submitted via search platform 145 and query results. For example, query matching manager 150 may facilitate matches between queries and content items of content providing platform 120. In another example, query matching manager 150 may facilitate matches between queries and advertisements of advertisement platform 165. Query matching manager 150 may facilitate operations of recommendation platform 157 by managing connections between user queries and recommended content items, recommended advertisements, etc. Query matching manager 150 may utilize one or more knowledge graphs of knowledge graph platform 160 in managing operations related to providing query match results.

In some embodiments, communication applications 115 installed on client devices 110 may be associated with a user account, e.g., a user may be signed in to an account on the client device 110. In some embodiments, multiple client devices 110 may be associated with the same client account. In some embodiments, operations of one or more platforms of content platform system 102 (e.g., advertisement platform 165, recommendation platform 157) may be performed responsive to the client devices being associated with a particular user account.

In some embodiments, client device 110 may include one or more data stores. Data stores may include commands (e.g., instructions, which cause operations when executed by a processing device) to render a UI (e.g., user interface 116). The instructions may include commands to render a content component and an explainability component.

In some embodiments, the one or more server machines 106 may include computing devices such as rackmount servers, router computers, server computers, personal computers, mainframe computers, laptop computers, tablet computers, desktop computers, etc., and may be coupled to one or more networks 105. Server machines 106 may be independent devices or part of any of the platforms (e.g., content providing platform 120, social network platform 160, etc.).

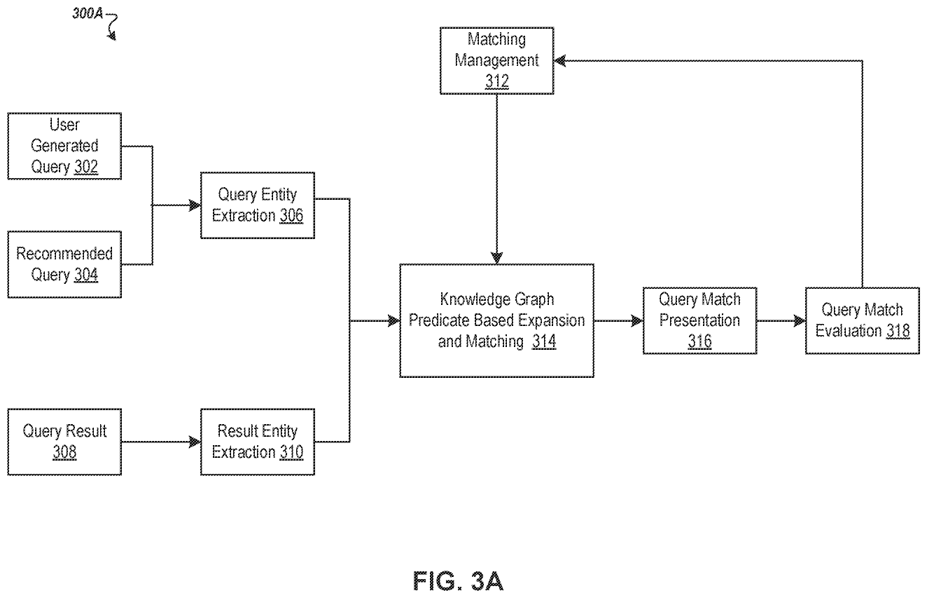

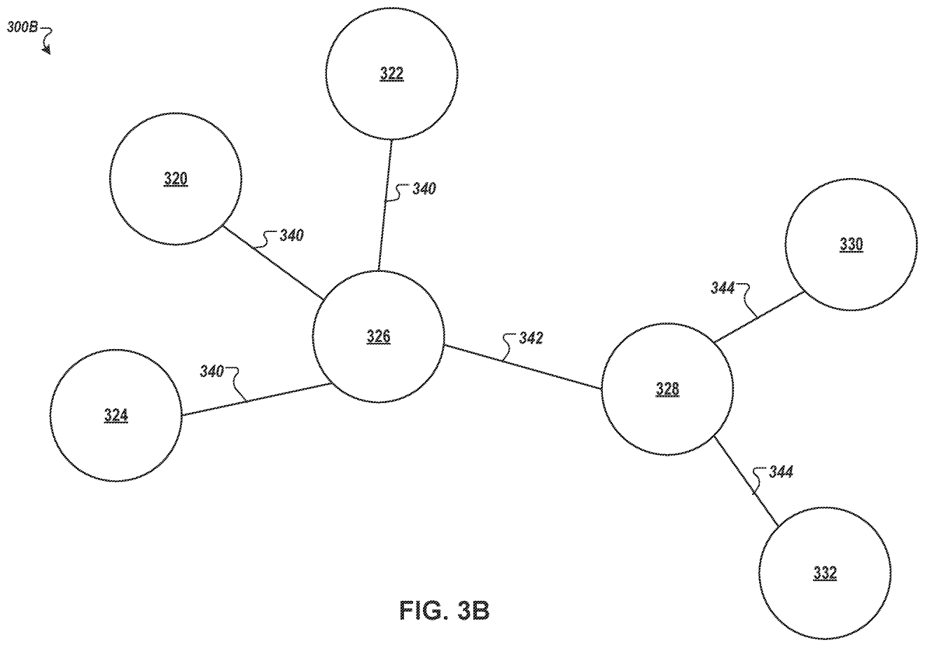

Knowledge Graph platform 160 may store and maintain one or more knowledge graphs. Knowledge graphs may be utilized in providing query/result matches. Knowledge graphs may be utilized in determining a set of entities associated with a query. Knowledge graphs may be utilized in determining as set of entities associated with a potential query result. Knowledge graphs may be utilized in expanding a set of entities. Knowledge graphs may be utilized in expanding an initial set of entities to an expanded set of entities. An example knowledge graph is discussed in connection with FIG. 3B.

Recommendation platform 157 may be used to generate and provide content recommendations (e.g., articles, videos, posts, news, games, etc.). Recommendations may be based on search history, content consumption history, followed/subscribed channel content, linked profiles (e.g., friend lists), popular content, etc. Recommendations may be based on a user's query history. Recommendations may include recommended queries, e.g., suggested topics, channels, etc. Search platform 145 may be used to allow users to query the one or more data stores 140 and/or one or more platforms and receive query results. Advertisement platform 165 may be used to provide advertisements. Advertisements may be provided responsive to receiving a query from a user. The query may be a search (e.g., a text search). The query may be user acceptance of a recommended query, e.g., based on a query suggested by recommendation platform 157.

Content providing platform 120 may be used to provide one or more users with access to content items 121 and/or provide the content items 121 to one or more users. For example, content providing platform 120 may allow users to consume, upload, download, and/or search for content items 121. In another example, the content providing platform 120 may allow users to evaluate content items 121, such as approve of (“like”), disapprove of, recommend, share, rate, and/or comment on content items 121. In another example, the content providing platform 120 may allow users to edit content items 121. The content providing platform 120 may also include a website (e.g., one or more webpages) and/or one or more applications (e.g., communication applications 115) that may be used to provide one or more users with access to the content items 121. For example, communication application 115 may be used by client device 110 to access content items 121. Content providing platform 120 may include any type of content delivery network providing access to content items 121.

Content providing platform 120 may include multiple channels (e.g., channel A 125, channel B 126, etc.). A channel may be a collection of content available from a common source, a collection of content having a common topic or theme, etc. The data content of a channel may be digital content chosen by a user, digital content made available by a user, digital content uploaded by a user, digital content chosen by a content provider, digital content chosen by a broadcaster, etc. For example, channel A 125 may include two videos (e.g., content items 121A-B). A channel may be associated with an owner, who may be a user that can perform actions on the channel. The content may be one or more content items 121. The data content of the channels may be pre-recorded content, live content, etc. although channels are described as one implementation of a content providing platform, implementations of the disclosure are not limited to content sharing platforms that provide content items 121 via a channel model.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline, such as a topic channel, of one or more platforms, one or more content items, etc.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

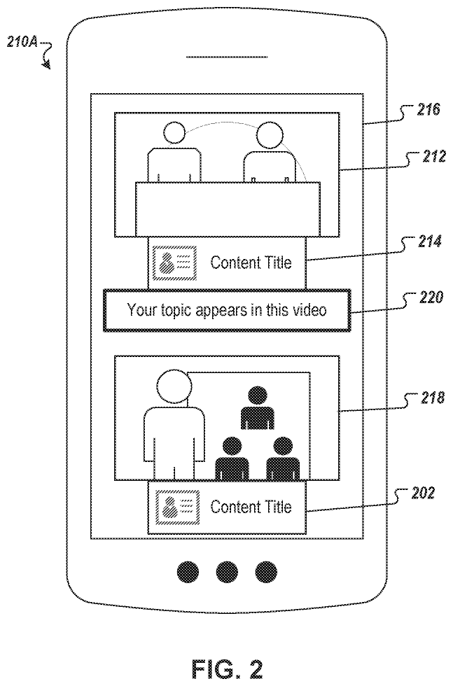

FIG. 2 is an example graphical user interface (GUI) of a communication application 216 of a client device 210A (e.g., communication application UI 116 of client device 110 of FIG. 1), including an explainability UI element, according to some embodiments. In some embodiments, client device 210A may receive a query request from a user. The query request may be a query input by the user, such as a text search. The query request may be a user selection of a recommended query, such as a recommended search topic. Client device 210A may provide the query to a server, e.g., of a content platform system.

Responsive to receiving a query from client device 210A, a system may provide instructions to client device 210A. Client device 210A may receive instructions including an indication that one or more UI elements are to be presented. UI elements may include indications of content items, indications of query match results, relevance descriptors of query match results, etc.

UI 116 may include one or more UI elements. Example UI 116 includes first content item indicator 212 (e.g., a video thumbnail, a UI element to present a content item, etc.), first content item information 214 (e.g., title, description, etc.), second content item indicator 218 (e.g., a second video thumbnail), and second content item description 202. UI 116 further includes relevance descriptor 220. Any other appropriate UI elements may be included in UI 116, e.g., additional interactive components (e.g., comments, like button, affiliated product links, donation links, etc.), additional social components, additional control components (e.g., UI elements to access a user profile, settings, or the like), etc.

In some embodiments, client device 210A may receive an indication that query match results are to be presented. A query match result may be presented by communication application (e.g., a mobile application, a desktop application, a web browser, etc.) 216. A list of query match results may be presented via communication application 216. The list of results may be a text list, image list, thumbnail list, etc. In some embodiments, client device 210A may display content item indicators 212, which may include text, images, etc. Content item indicators 212 may be associated with query match results. Content item indicators 212 may include indicators of items associated with one or more of a content providing platform, recommendation platform, search platform, advertisement platform, etc. In some embodiments, multiple query match results associated with items of different platforms may be presented (e.g., indicators associated with query match content items and indicators associated with query match advertisements may be displayed in the same list of items by communication application 216).

Client device 210A may receive an indication (e.g., from server machines 106) that a relevance descriptor 220 is to be displayed for a user. In some embodiments, client device 210A may display relevance descriptor 220 responsive to receiving a response to a request sent by client device 210A via a network, e.g., to content platform system 102 of FIG. 1. In some embodiments, relevance descriptor 220 may be displayed to a user responsive to a determination (e.g., by server machine 106) that a user may benefit by the presentation of the relevance descriptor 220. In some embodiments, relevance descriptor 220 may overlay or replace rendered components in a portion of screen space of device 210 that may include other UI elements, e.g., relevance descriptor 220 may appear “on top” of (e.g., overlaying portions of) UI 216 in a transparent, semi-transparent or non-transparent form. In some embodiments, relevance descriptor 220 may appear as associated with a particular UI element, a particular indicator of a query match, etc.

Relevance descriptor 220 includes a description of a relationship between a query and a query result. The description of relevance descriptor 220 may include text, images, etc. In one example, the description of relevance descriptor 220 may include an indication of an entity overlap between a query and a query result (e.g., topic overlap between the topic in the query of the user and the topic of a query result, such as a query result associated with content item indicator 212). In another example, the description of relevance descriptor 220 may include an indication of a predicate connection between entities of a query. In yet another example, the description of relevance descriptor 220 may include an indication of a predicate connection between entities of a query result. In still another example, the description of relevance descriptor 220 may include an indication of a predicate connection between an entity of an initial set of entities and an entity of an expanded set of entities. The description of relevance descriptor may be based on multiple query/result relationships. For example, if multiple entities overlap between entities associated with the query and entities associated with the query result, the relevance descriptor may be based on more than one entity, more than one predicate relationships associated with the overlapping entities, etc. In some embodiments, the relevance descriptor may be a visual indication of a level of relevance between the query and query result, such as an icon, plot, graphic, etc. The relevance descriptor may be based on a number of overlapping entities, a relevance quality of overlapping entities, a confidence level in the relevance of overlapping entities, predicate relationships, and/or the query result to the query, etc.

FIG. 3A is a block diagram of a flow of operations 300A for query/result matching using expanded sets of entities, according to some embodiments. Operations 300A may be performed by one or more components of system 100 of FIG. 1. Operations 300A may be performed in part by client device 110, server machine 106, query matching manager 150, data store 140, and/or one or more platforms of content platform system 102.

Operations 300A may include matching a query to one or more query results. Query results may be referred to as content items. In one example, query results may be media items such as text, images, video, audio, etc. In another example, query results may be advertisements supplied responsive to receiving a query from a user device.

A user generated query 302 may be provided via a user device. The user generated query 302 may be provided via a UI of a user device. The user generated query may be provided to the system performing operations 300A via a network. The user generated query may include a user search. The user generated query 302 may include a text search.

In some embodiments, a recommended query 304 may be provided via a user device. A recommendation platform may enable presenting a user with a recommended query, such as a recommended topic, recommended product, recommended channel, recommended genre of content, etc. Upon user interaction with a UI element presenting the recommendation, a query may be generated.

A query may be provided to query entity extraction 306. Query entity extraction 306 may generate an initial set of entities associated with the query. In some embodiments, the initial set of entities may be generated using substrings of the query. In some embodiments, the initial set of entities may be generated using predictions of user intent, e.g., based on previous queries, based on user history, based on likely typographical errors, etc. In some embodiments, the initial set of entities may be generated using a machine learning model, e.g., by providing the query as input to a trained machine learning model and receiving as output a list of initial entities associated with the query. The machine learning model may be trained using training data that includes prior queries and corresponding query results selected by one or more users. In some embodiments, query entity extraction 306 may include human entity assignment.

One or more query results 308 are provided. Operations related to query results may be performed and stored to be utilized responsive to receiving a query. Query results may be provided to result entity extraction 310. Result entity extraction 310 may share one or more features with query entity extraction 306. Result entity extraction 310 may include substring analysis, human labeling, machine learning labeling, etc.

In some embodiments, a query and a query result may undergo operations of knowledge graph predicate based on expansion and matching 314. An initial set of entities may be expanded to an expanded set of entities. For example, entities associated with a query may be expanded. In another example, entities associated with a query result may be expanded. In some embodiments, entities may be expanded according to predicate logic. Predicate logic may be maintained by matching management 312. Matching management 312 may maintain one or more sets of predicates, instructions for matching, instructions for displaying relevance descriptors to a user, etc. Entities associated with a query may be expanded a target number of times, until one or more conditions are satisfied—e.g., until a target number of entities is included in the set of entities, until a target number of entity matches with query results are found, until a target number of matching query results are found, etc. In some embodiments, entities associated with a query result may similarly be expanded. Various sets of predicates may be used for entity expansion. For example, a set of predicates may be used for query entity expansion. In another example, a set of predicates may be used for query result entity expansion. In yet another example, multiple sets of predicates may be used for an expansion, e.g., successive expansion operations may utilize different (possibly overlapping) sets of predicates. In some embodiments, one or more sets of predicates may be used in determining whether to provide a user with a relevance descriptor. A query and a query result may be matched when one or more entities overlaps between the query and the query result.

In some embodiments, entities of a set of entities may be assigned a confidence score. The confidence score may represent a calculated chance that the entity is relevant to the associated object (e.g., query, query result, etc.). The confidence score may represent a calculated chance that a user would recognize a relationship between the entity and the associated object. In some embodiments, the confidence score may be a number between zero and one, with zero representing no confidence that the entity is related to the object, and one representing complete certainty that the entity is related to the object. In some embodiments, predicates may include a confidence score. The confidence score may indicate a certainty that entities connected by the predicate are related. The confidence score of a predicate may indicate a certainty that a user will recognize a relationship between entities connected via a predicate, a query and a query match with overlapping entities provided by the predicate, etc. In some embodiments, a total confidence score representing a likelihood that a query and a query match are relevant may be generated. In some embodiments, a total confidence score representing a probability that a query and a query match are relevant may be generated.

Operations of knowledge graph predicate based expansion and matching 314 may further include operations of providing a relevance descriptor to a user. In one example, a relevance descriptor may be based on one or more overlapping entities between a query and an associated query result. In another example, a relevance descriptor may be based on a predicate connection facilitating the overlap of one or more entities between the query and the associated query result. In some embodiments, a determination may be made of whether to provide a relevance descriptor. Determining whether to provide a relevance descriptor may be based on one or more confidence scores, whether an overlapping entity is included in a set of entities, whether a predicate used in matching the query and result is included in a set of predicates, etc. In some embodiments, a determination may be made of which elements to include in a relevance descriptor. A query and a query match may have multiple overlapping entities. In some embodiments, selection of which entity or entities to base a relevance descriptor on may be performed based on one or more confidence scores. In some embodiments, a combination of confidence scores may be used, such as a confidence score that a first entity is related to the query, confidence that a second entity is related to the query result, and a confidence that the query is related to the query result. A multiplicative confidence score may be utilized, e.g., multiplying a number of confidence scores together and utilizing the resultant multiplicative confidence (e.g., multiplicative probability) in making a determination.

Upon finding a match between a query and one or more query results, one or more query results are provided to query match presentation 316. Query match presentation 316 may include determining which of the matches to provide to a user. In some embodiments, a relevance score, confidence score, or the like may be referenced in determining whether to provide a query match to a user, in determining which query match to provide to the user, etc. In some embodiments, a query match may be an advertisement. In some embodiments, an advertisement auction system may be utilized in determining which query match to provide to a user, whether to provide a query match to a user, etc.

Flow can then continue to query match evaluation 318. Query match evaluation 318 may include determining one or more metrics of relevance. For example, query match evaluation 318 may include determining one or more metrics of relevance between a query and a query result. In another example, query match evaluation 318 may include determining one or more metrics of relevance of a relevance descriptor. In yet another example, query match evaluation 318 may include human evaluation of relevance. In still another example, query match evaluation 318 may include machine evaluation of relevance, e.g., by providing the query, query match, and/or relevance descriptor to a trained machine learning model and receiving an indication of relevance. The machine learning model may be trained using training data including training inputs associated with prior queries and target outputs of corresponding indicators of relevance. In some embodiments, query match evaluation 318 may include monitoring indications of relevance, such as user click rate, user dwell rate, user purchase rate, user watch time, or the like.

Results of query match evaluation 318 may feed back into matching management 312. In some embodiments, one or more sets of predicates may be updated based on output of query match evaluation 318. In some embodiments, one or more relevance scores may be updated based on output of query match evaluation 318. In some embodiments, one or more methods of determining relevance scores may be updated based on output of query match evaluation 318. In some embodiments, operations 300A may be performed offline, e.g., to build up an initial library of sets of predicates. In some embodiments, operations 300A may be performed online, e.g., to update matching management 312 based on data generated during use of the query matching system.

FIG. 3B is an example knowledge graph 300B including entities and predicates, according to some embodiments. Knowledge graph 300B is a representation of relationships between various articles. For example, knowledge graph 300B may include nodes 320-332 and 340-344. Knowledge graph 300B may represent a visualization of a data relationship structure that may exist in memory.

In some embodiments, nodes 320-332 of knowledge graph 300B correspond to entities. Each entity may represent an object, media item, event, concept, product, situation, etc. Query items, content items, advertisement items, and other potential query match items may be associated with one or more entities. Entities initially associated with an item may be directly related to the item (e.g., a subject of a video), mentioned or included in the item (e.g., a substring of a query), etc.

Entities may represent real-world entities. Predicate relationships may model relationships between the real-world entities. For example, predicate relationships may model physical relationships between physical realities. Entities may represent physical entities with a geographical position (such as building, addresses, landmarks, landmasses, etc.). Entities may represent laws of physics, associated technologies, physical components of a mechanism, chemical elements or compounds, biological entities such as proteins, nucleic acids, organisms, etc.

Edges 340-344 of knowledge graph 300B may correspond to predicates. Predicates describe relationships between entities. In some embodiments, predicates may indicate the nature of a connection between entities. In some embodiments, a single entity may be connected to many others by a number of predicates. In some embodiments, a pair of entities may be connected by multiple predicates.

Predicates may indicate a type of connection between entities, such as one entity being a subset of the other, both entities belonging to a category, etc. Entities may represent physical entities with geographical positions, and predicate relationship may indicate a region both physical entities belong to. Entities may represent physical components of a mechanism and a predicate relationship may indicate a coupling between the components, that the components may be used in the same mechanism, etc. Entities may represent elements or chemical compounds, and a predicate may indicate a chemical relationship such as a reaction utilizing the chemical compounds. Entities may represent biological objects, and the predicate relationship may indicate one or more relationships between the biological objects, such as a protein being included in a cellular system, one organism living in a symbiotic relationship with another organism, etc.

As an example of entity/predicate logic, a query may include the title of a book. Node 320 may represent the book included in the query. The set of initial entities may include the entity of node 320. Edges 340 may indicate that entities associated with nodes 320, 322, and 324 belong to a book series represented by node 326. Predicate logic (e.g., of query matching manager 150 of FIG. 1) may indicate that expansion of query entities may include expansion along a predicate edge indicative of a series of books that an entity belongs to. Predicate logic may include a single expansion from node 320 to node 326, or multiple expansions to include nodes 322 and nodes 324 in an expanded set of entities, along edges 340. A series of expansions of entities via predicate expansion may each utilize the same set of predicates. A series of expansions of entities via predicate expansion may utilize two or more different sets of predicates. Node 326, corresponding to the entity of a book series, may further be connected to node 328 by edge 342. Edge 342 may correspond to a predicate indicating a book's author, and node 328 may correspond to an entity of the author of the book included in the query. Edges 344 may connect to nodes 330 and 332, which may be further books by the same author as associated with node 328. Depending on predicate entity expansion logic, one or more curated sets of predicates, etc., some or all of the entities corresponding to nodes 320-332 may be included in an expanded set of entities associated with a query, query results, etc.

There may be additional connections in the knowledge graph that are not shown in FIG. 3B. Continuing with the example of a book, there may be additional connections between each of nodes 320, 322, and 324 and node 328, indicating that the books of nodes 320-324 were written by the author represented by node 328. There may be additional edges between nodes 320, 322, 324, 330, and 332 indicating a predicate relationship that the books are all written by the same author, etc.

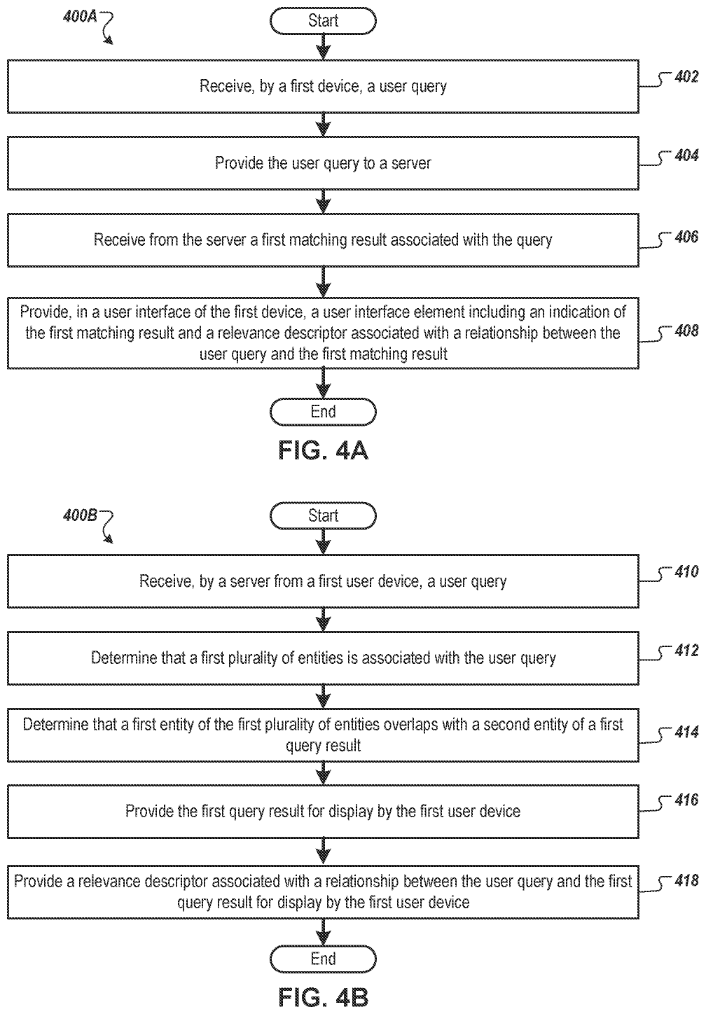

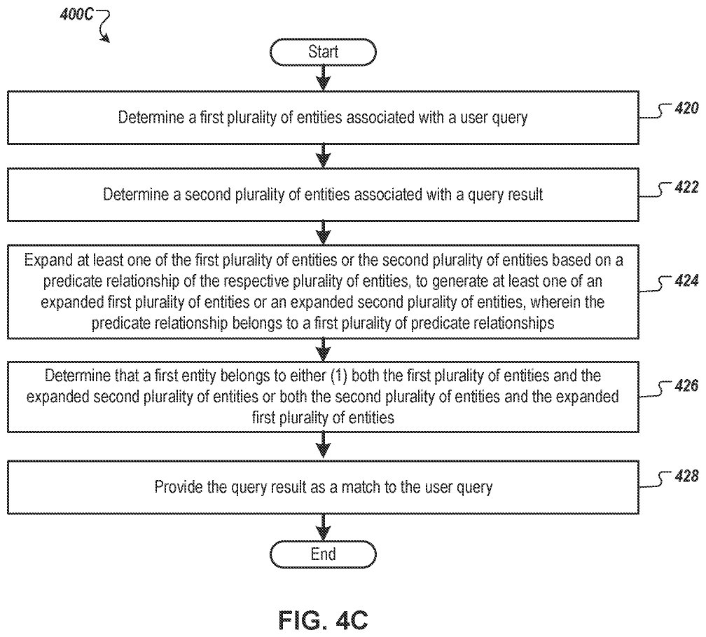

FIGS. 4A, 4B and 4C are flow diagrams of methods performed according to various embodiments of the present disclosure.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

FIG. 4A is a flow diagram of a method 400A for providing a relevance descriptor associated with a query result to a user, according to some embodiments. Method 400A can be performed by processing logic that can include hardware (circuitry, dedicated logic, etc.), software (e.g., instructions run on a processing device), or a combination thereof. In one implementation, some or all of the operations of method 400A can be performed by one or more components of client device 110 of FIG. 1. In some embodiments, some or all of the operations of method 400A can be performed by communication application 115, as described above.

At block 402, processing logic of a first device receives a user query. The first device may be a user device, a client device, etc. The user query may be a search initiated by a user. In another example, the user query may be a recommended query, accepted by the user.

At block 404, processing logic provides the user query to a server. The server may be of a content providing platform. The user query may be provided via a network. The first device may communicate with the server via an application stored on the first device, e.g., a web browser, a specific application associated with a content providing platform, etc.

At block 406, processing logic receives from the server a first matching result associated with the query. the first matching result may be a content item. In another example, the first matching result may be an advertisement.

At block 408, processing logic provides a user interface element. The user interface element is provided in a user interface of the first device. The user interface includes an indication of the first matching result and a relevance descriptor. The relevance descriptor is associated with a relationship between the user query and the first matching result. The relevance descriptor may include a substring of the user query. In one example, the relevance descriptor may include a reference to an entity associated with the user query. In another example, the relevance descriptor may include a reference to an entity associated with the first matching result. In yet another example, the relevance descriptor may include a reference to a predicate connecting two entities associated with the user query. In still another example, the relevance descriptor may include a reference to a predicate connecting two entities associated with the matching result.

FIG. 4B is a flow diagram of a method 400B for utilizing entity overlap to provide a relevance descriptor for a query result, according to some embodiments. Method 400B can be performed by processing logic that can include hardware (circuitry, dedicated logic, etc.), software (e.g., instructions run on a processing device), or a combination thereof. In one implementation, some or all of the operations of method 400B can be performed by one or more components of content platform system 102 of FIG. 1. In some embodiments, some or all of the operations of method 400B can be performed by query matching manager 150, as described above.

At block 410, processing logic of a server receives a user query from a first user device. The user query may be a user-generated query, such as a text search. The user query may be a user-accepted recommended query, such as a topic recommendation.

At block 412, processing logic determines that a first plurality of entities is associated with the user query. In some embodiments, determining the first plurality of entities is associated with the user query may include extracting substrings associated with entities from the user query. In some embodiments, determining the first plurality of entities is associated with the user query may include providing the user query to a trained machine learning model. In some embodiments, determining the first plurality of entities is associated with the user query may include performing knowledge graph predicate expansion of entities.

At block 414, processing logic determines that a first entity of the first plurality of entities overlaps with a second entity of a first query result. Overlapping entities may be associated with the same object, may be represented with the same node on a knowledge graph, etc. The second entity may be associated with the first query result. Optionally, the second entity may have been previously associated with the first query result. In some embodiments, the second entity may be included in a set of entities that are associated with the first query result. Determining a set of entities associated with the first query result may include similar operations to determining a set of entities associated with the user query.

In some embodiments, determining the first plurality of entities is associated with the user query may include determining that a third entity is directly related to the user query, e.g., via substring analysis. In some embodiments, determining the first plurality of entities is associated with the user query may further include determining that an entity of the first plurality of entities has a relationship with the third entity. The relationship between the third entity and the first entity may be defined by a predicate relationship. The predicate relationship may correspond to an edge of a knowledge graph. In some embodiments, the predicate connecting the third entity and the first entity may belong to a set of predicates. The set of predicates may be a set of predicates used for entity expansion of entities associated with user queries. In some embodiments, the first plurality of entities may include the first entity and the third entity.

In some embodiments, determining that the first plurality of entities is associated with the user query may include determining that a second plurality of entities is directly associated with the user query. In one example, the second plurality of entities may be determined via substringing, application of a trained model, etc. In another example, the second plurality of entities may be a subset of the first plurality of entities. Entities that are included in the first plurality of entities but not the second plurality of entities may be grouped as a third plurality of entities. In some embodiments, determining that the first plurality of entities is associated with the user query may further include determining that each of the third plurality of entities is related to one or more of the second plurality of entities by a predicate relationship belonging to a first set of predicate relationships. In some embodiments, the first set of predicate relationships may be a set used for predicate expansion of entities associated with a query. In some embodiments, determining the first plurality of predicate relationships includes curating predicates for user-perceived relevance.

At block 416, processing logic provides the first query result for display by the first user device. At block 418, processing logic provides a relevance descriptor associated with a relationship between the user query and the first query result for display by the first user device. In one example, the relevance descriptor may be related to the first entity (e.g., may include a description of the first entity). In another example, the relevance descriptor may be related to the second entity. In some embodiments, the relevance descriptor may be based on a predicate. The predicate may be included in a chain of connections between entities of the first plurality of entities. In some embodiments, providing the relevance descriptor may include determining whether the predicate belongs to a set of predicates to be used for generating relevance descriptors. The set of predicates used for generating relevance descriptors may be a subset of a set of predicates used for entity expansion of entities of a query, a subset of predicates used for entity expansion of entities of a query result, etc.

FIG. 4C is a flow diagram of a method 400C for providing a query result as a match to a query using predicate expansion of entities, according to some embodiments. Method 400C can be performed by processing logic that can include hardware (circuitry, dedicated logic, etc.), software (e.g., instructions run on a processing device), or a combination thereof. In one implementation, some or all of the operations of method 400C can be performed by one or more components of content platform system 102 of FIG. 1. In some embodiments, some or all of the operations of method 400C can be performed by query matching manager 150, as described above.

At block 420, processing logic determines a first plurality of entities associated with a user query. The first plurality of entities may be an initial set of entities associated with the user query. At block 422, processing logic determines a second plurality of entities associated with a query result. The second plurality of entities may be an initial set of entities associated with the query result.

At block 424, processing logic expands at least one of the first plurality of entities or the second plurality of entities. The expansion is based on a predicate relationship. In some embodiments, the expansion may be based on a knowledge graph, where the entities correspond to nodes of the knowledge graph and predicates correspond to edges of the knowledge graph. In some embodiments, the predicate of the predicate relationship used in entity expansion belongs to a first set of predicate relationships. The first set of predicate relationships may be a curated set, curated for entity expansions operations. In some embodiments, entity expansion can generate at least one of an expanded first plurality of entities or an expanded second plurality of entities.

In some embodiments, generating the first set of predicate relationships may include receiving a test query. The test query may be a user query, a synthetic query, part of a random or systematic query generation operation, etc. In some embodiments, generating the first set of predicate relationships may further include determining a third plurality of entities directly associated with the test query. The third plurality of entities may be an initial set of entities associated with the test query. In some embodiments, generating the first set of predicate relationships may further include expanding the third plurality of entities based on a test predicate relationship. The test predicate relationship may be a part of a test set of predicate relationships. In some embodiments, expanding the third plurality of entities may generate an expanded third plurality of entities. The expanded third plurality of entities may include a second entity. In some embodiments, generating the first set of predicate relationships may further include determining that a test query result is associated with the second entity. The second entity may be included in an initial set of entities of the test query, an expanded set of entities of the test query, etc. In some embodiments, generating the first set of predicate relationships may further include providing the test query and the test query result to an evaluation module. The evaluation module may provide human evaluation of the test query and the test query result. In some embodiments, generating the first set of predicate relationships may further include receiving output of the evaluation module. The output may be associated with the test query and the test query result. In some embodiments, generating the first set of predicate relationships may further include determining whether to include the test predicate relationship in the first plurality of predicate relationships based on the output of the evaluation module.

In some embodiments, processing logic may further provide instructions to cause a user interface element to be displayed by a user device. The user interface element may include an indication of the query result. In some embodiments, the first plurality of predicate relationships may be updated based on user interaction with the user interface element.

At block 426, processing logic determines that a first entity belongs to two sets of entities. The two sets may be, for example, the first plurality of entities and the expanded second plurality of entities. In another example, the two sets of entities may be the second plurality of entities and the expanded first plurality of entities.

At block 428, processing logic provides the query result as a match to the user query. The query result may be provided to a user device for presenting to the user. Providing the query match may be performed responsive to determining that the first entity belongs to two sets of entities. A relevance descriptor may further be provided for display on the user device. The relevance descriptor may be based, for example, on the first entity, the first query result, the user query, the predicate relationship (e.g., the predicate relationship used in expanding a set of entities), etc. In some embodiments, determining whether to provide the relevance descriptor may be based on the predicate relationship and may include, for example, determining whether the predicate relationship belongs to a second set of predicate relationships. The second set of predicate relationships may be a subset of the first plurality of predicate relationships.

In some embodiments, processing logic may further provide the user query and the query result to a relevance model, receive a relevance score from the relevance model, and update the first plurality of predicate relationships based on the relevance score.

In some embodiments, processing logic may further obtain (e.g., determine) one or more confidence scores. For example, a confidence score may be obtained expressing a confidence that the first entity is related to the user query. In another example, a confidence score may be obtained expressing a confidence that the first entity is related to the query result. In yet another example, a confidence score may be obtained expressing a confidence that the user query is related to the query result. In some embodiments, determining whether to provide the query match may be based on one or more of these confidence scores. In some embodiments, determining whether to provide a relevance descriptor may be based on one or more of these confidence scores. In some embodiments, basing performance of an operation on confidence scores may include combining multiple confidence scores (e.g., by multiplying confidence scores) and basing performance on the result of the combining.

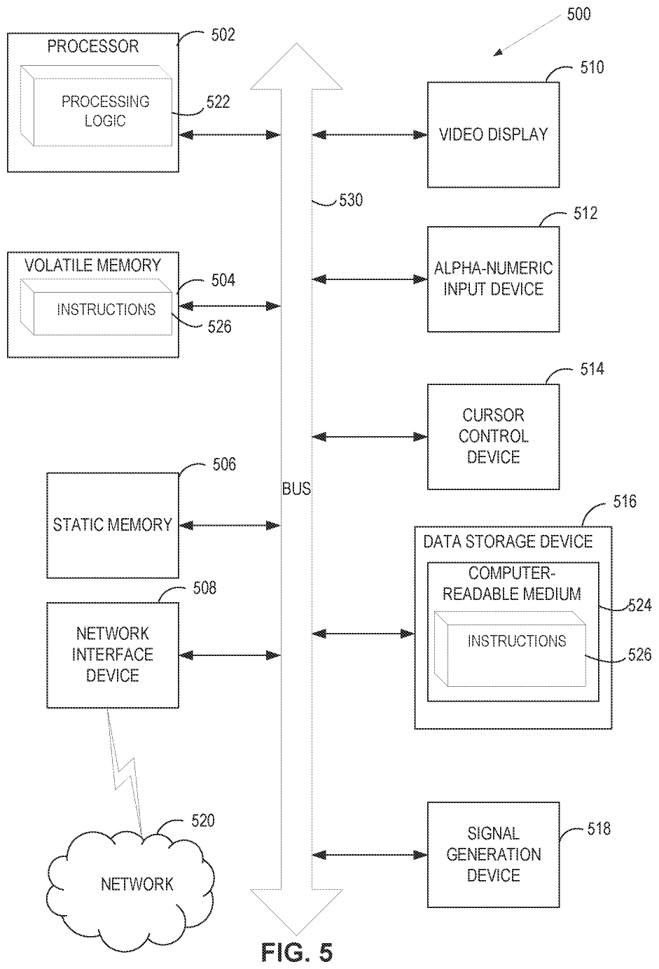

FIG. 5 is a block diagram illustrating an exemplary computer system 500, according to some embodiments. Computer system 500 may be one of server machines 106 or client device 110 of FIG. 1. The machine may operate in the capacity of a server or an endpoint machine in an endpoint-server network environment, or as a peer machine in a peer-to-peer (or distributed) network environment. The machine may be a television, a personal computer (PC), a tablet PC, a set-top box (STB), a Personal Digital Assistant (PDA), a cellular telephone, a web appliance, a server, a network router, switch, or bridge, a gaming console, a digital media streaming device, or any machine capable of executing a set of instructions (sequential or otherwise) that specify actions to be taken by that machine. Further, while only a single machine is illustrated, the terms “machine,” “computer,” “processing device,” etc., shall also be taken to include any collection of machines that individually or jointly execute a set (or multiple sets) of instructions to perform any one or more of the methodologies discussed herein.

Example computer system 500 includes a processing device (processor) 502, a volatile memory 504 (e.g., read-only memory (ROM), flash memory, dynamic random access memory (DRAM) such as synchronous DRAM (SDRAM), double data rate (DDR SDRAM), etc.), a static memory 506 (e.g., flash memory, static random access memory (SRAM), etc.), and a data storage device 516, which communicate with each other via a bus 530.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 502 may also be one or more special-purpose processing devices such as an application specific integrated circuit (ASIC), a field programmable gate array (FPGA), a digital signal processor (DSP), network processor, or the like. The processor 502 includes processing logic 522 (e.g., for facilitating query matching, entity expansion, relevance descriptor generation, etc.) for performing operations discussed herein. Processing logic 522 may be configured to execute instructions 526.

Computer system 500 can further include a network interface device 508. The computer system 500 also can include a video display unit 510 (e.g., a liquid crystal display (LCD) or a cathode ray tube (CRT)), an alpha-numeric input device 512 (e.g., a keyboard, and alphanumeric keyboard, a motion sensing input device, touch screen), a cursor control device 514 (e.g., a mouse), and a signal generation device 518 (e.g., a speaker).

Data storage device 516 can include a non-transitory machine-readable storage medium 524 (also computer-readable storage medium) on which is stored one or more sets of instructions 526 (e.g., for obtaining optimized encoder parameter settings) embodying any one or more of the methodologies or functions described herein. The instructions can also reside, completely or at least partially, within the volatile memory 504 and/or within the processor 502 during execution thereof by the computer system 500, the volatile (e.g., main) memory 504 and the processor 502 also constituting machine-readable storage media. The instructions can further be transmitted or received over a network 520 via the network interface device 508.

While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities.

What is claimed is:

1. A method, comprising:
receiving, by a processor of a first user device, a user query;
providing the user query to a server;
receiving from the server a matching result associated with the user query, and
providing, in a user interface (UI) on the first user device, a plurality of UI elements comprising:
a first UI element presenting the matching result associated with the query; and
a second UI element presenting a relevance descriptor associated with a relationship between the user query and the matching result associated with the user query.

2. The method of claim 1, wherein the relevance descriptor comprises a substring of the user query.

3. The method of claim 1, wherein the matching result associated with the user query is determined using a knowledge graph comprising a plurality of nodes each representing one of a plurality of entities and a plurality of edges each representing a predicate relationship between respective two entities of the plurality of entities.

4. The method of claim 3, wherein the relevance descriptor is determined based on an overlap between one or more entities associated with the user query and one or more entities associated with the matching result associated with the user query.

5. A method, comprising:
receiving, by a server device from a first user device, a user query;
determining that a first plurality of entities is associated with the user query, wherein the first plurality of entities comprises a first entity directly related to the user query, and wherein a first query result comprises a second entity;
determining that the first entity of the first plurality of entities overlaps with the second entity of the first query result;
determining that a third entity is directly related to the user query;
determining that the first entity has a relationship with the third entity defined by a first predicate, wherein the first plurality of entities comprises the third entity;
providing, based on the first entity, the second entity and the third entity, the first query result for display by the first user device; and
providing a relevance descriptor associated with a relationship between the user query and the first query result for display by the first user device.

6. The method of claim 5, wherein the relevance descriptor is based on the first entity.

7. (canceled)

8. The method of claim 5, wherein the relevance descriptor is based on the first predicate.

9. The method of claim 5, wherein determining that the second entity is associated with the first query result comprises:
determining a fourth entity is directly related to the first query result; and
determining that the fourth entity has a relationship with the second entity defined by a first predicate.

10. The method of claim 9, wherein the relevance descriptor is based on the first predicate, and wherein providing the relevance descriptor comprises determining that the first predicate belongs to a first plurality of predicates associated with relevance descriptors, wherein the first plurality comprises a subset of a second plurality of predicates, and wherein the second plurality of predicates is to be used to determine a set of entities associated with a query result.

11. The method of claim 5, wherein determining that the first plurality of entities is associated with the user query comprises:
determining that a second plurality of entities is directly associated with the user query, wherein the second plurality of entities is a subset of the first plurality of entities, and wherein a third plurality of entities consists of entities comprising the first plurality of entities that do not comprise the second plurality of entities; and
determining that each of the third plurality of entities is related to one or more of the second plurality of entities by a predicate relationship belonging to a first plurality of predicate relationships, wherein determining the first plurality of predicate relationships comprises curating predicates of the first plurality of predicates for relevance as perceived by a user.

12. A method, comprising:
determining, by a processing device, a first plurality of entities associated with a user query;
determining, by the processing device, a second plurality of entities associated with a query result;
expanding at least one of the first plurality of entities or the second plurality of entities based on a predicate relationship of the respective plurality of entities, to generate at least one of an expanded first plurality of entities or an expanded second plurality of entities, wherein the predicate relationship belongs to a first plurality of predicate relationships;
determining that a first entity belongs to either:
the first plurality of entities and the expanded second plurality of entities, or
the second plurality of entities and the expanded first plurality of entities; and
providing the query result as a match to the user query.

13. The method of claim 12, further comprising:
providing a relevance descriptor for display by a user device, wherein the relevance descriptor is based on the query result, the user query, and the first entity.

14. The method of claim 13, wherein the relevance descriptor is further based on the predicate relationship.

15. The method of claim 12, wherein generating the first plurality of predicate relationships comprises:
receiving a test query;
determining a third plurality of entities directly associated with the test query;
expanding the third plurality of entities based on a test predicate relationship to generate an expanded third plurality of entities, wherein the expanded third plurality of entities comprises a second entity;
determining that a test query result is associated with the second entity;
providing the test query and the test query result to an evaluation module, wherein the evaluation module provides human evaluation of the test query and the test query result;
receiving, from the evaluation module, output of the evaluation module associated with the test query and the test query result; and
determining whether to include the test predicate relationship in the first plurality of predicate relationships based on the output of the evaluation module.

16. The method of claim 15, further comprising:
causing a user interface (UI) element to be provided to a user, wherein the UI element comprises an indication of the query result; and
updating the first plurality of predicate relationships based on user interaction with the UI element.

17. The method of claim 15, further comprising:
providing the user query and the query result to a relevance model;
receive a relevance score from the relevance model; and
updating the first plurality of predicate relationships based on the relevance score.

18. The method of claim 12, further comprising determining whether to provide a relevance descriptor for display by a user device, wherein the determination is based on whether the predicate relationship belongs to a second plurality of predicate relationships, and wherein the second plurality of predicate relationships is a subset of the first plurality of predicate relationships.

19. The method of claim 12, further comprising:
obtaining a first confidence score indicative of a certainty that the first entity is related to the user query; and
obtaining a second confidence score indicative of a certainty that the first entity is related to the query result, wherein determining to provide the query result as a match to the user query is performed based on the first confidence score and the second confidence score.

20. The method of claim 19, wherein the first confidence score is associated with a first probability, the second confidence score is associated with a second probability, and the determining to provide the query result as a match to the user query is based on a multiplicative probability.
